(19) United States
(12) Patent Application Publication
(10) Pub. No.: US 2012/0005143 A1
(43) Pub. Date: Jan. 5, 2012

(54) Model and algorithm for automated item generator of the graphic intelligence test

(76) Inventors: JinShuo Liu, Wuhan (CN); Li Yan, Gatineau (CA); Juan Deng, Wuhan (CN); Junxing Yang, Wuhan (CN); Yang yang Lu, Wuhan (CN); Yu Long Zhang, Muhan (CN); Xin Chen, Wuhan (CN)

(21) Appl. No.: 12/927,852

(22) Filed: Nov. 29, 2010

Related U.S. Application Data
(60) Provisional application No. 61/283,609, filed on Dec. 7, 2009.

(51) Int. Cl. G06N 5/02

(52) U.S. Cl. 706/46

(57) ABSTRACT

A model for automated item generator of the graphic intelligence test solves the tremendous time consuming problem for manually devising the graph intelligence item. At the same time, the invention can automated generate more complicated, more transformations and better layout graph for intelligence test, which are hard to predict. The model utilizes the 12 branch tree as the expressing pattern of matrix graph item, and 8 branch trees as the expressing pattern of series graph item. The automated generating item methods have been presented, and the difficulty of the item has also been validated with the similarity of the optional answers and difficulties of the rules and complexity of the sub-graph. The best feature of the model is that a big amount of the graph item for intelligence test can be generated at one time by the computer, instead of manually devising the matrix graph or series graph for intelligence test. With the model, the online intelligence test platform can update the test database automatically, thus the intelligence and the ability of the examinee can be evaluated breaking through the barrier of the language, culture and education background.

### CROSS-REFERENCE TO RELATED APPLICATIONS

This application claims the benefit of Provisional Application No. 61/283,609, filed Dec. 07, 2009, the disclosure of which is incorporated by reference.

### FIELD OF THE INVENTION

The present invention relates to psychometric, neuropsychological and neurophysiologic tests for measuring intelligence to the use of graphic intelligence. With the invent the psychologist can use the computer to automated generate graphic items for the intelligence test.

### BACKGROUND OF THE INVENTION

Graphic intelligence test is an adaptive computer based intelligence determining system. Graphic intelligence test is based on the item response theory model. This system mainly uses the graphs as the tool to test the abilities of solving the problem of the examinees. Graphic intelligence test can neglect the education background, culture background, language difference. It has been adopted by a lot of education institutions or the psychology institutions to exam the intelligence of human resource of many races.

When doing the test, to avoid the examinees' improving the score by more practices, thus further affect the equality and accuracy, the database of the items need to be updated routinely. Now the international psychology institutes devise the items manually. It is time wasting to devise the items and to determine the difficulty levels of them especially when updating the item database at one time. At the same time, inputting the items into the database and validating these items one by one manually is also a tremendous work. How to devise the items of different difficulty levels and determine their difficulties automatically is a long term and urgent task for the psychologists.

Now FAIRAVEN and BETTERAVEN have only solved the problem of how to get the right answer of matrix graph. These two system models have not involved how to generate the item automatically. To infer the right answer of the problem, they only consider the complexity of the graph, the whole layout, variety of the dimension and items. The graphs they generated has small amount of rules and simple. The number of the sample graphs is small. They have not touched that the similarity of the optional answers are also important features to affect the difficulty of the item. Patent application no 663363 Device and method for assessing cognitive speed by Buschke; Herman, 1991, May only use the test speed of the response, but the similar motivation is the patent also utilizes computer as the testing tool.

### SUMMARY OF THE INVENTION

In accordance with the present invention, 12_branch tree model has been devised representing the matrix graph item, and 8_branch tree model represent serial graph item. By retrieving the 12_branch tree and 8_branch tree, big amount of items can be generated. Difficulties of the item validating model also have been devised. The invention compromises two parts: automated item generator and item difficulty predication model.

In a basic embodiment of the present invention, ‘the general shape database’, ‘texture database’, ‘rule database’ are designed firstly for automated item generator. Secondly, randomly select the elements from the databases. Thirdly, construct the nine sub-graphs using the elements which have been selected out at the last step. From the 9 sub-graphs, a matrix graph can be built up. With the matrix graph, a 9 sub-branch tree can be generated. From the 9 sub-branch tree, 3 sub-branch parts (distracters) can be built up by modifying small part of the sub-branch tree, then totally 12 branch tree is constructed. When construct 3 distracters, what we need to do is just modify one or two node of the sub-tree. Besides this, we also need to be careful about the shape and texture should be the elements of the sub-tree. Distracters can't be generated by modifying any node of the 9 sub-tree. The whole 12 branch tree is a pattern of one item. For the serial graph problem, the method is similar. Initially 5 sub-tree branch can be set up firstly instead of the 9 sub-tree branch, and then the 8 branch tree is set up as the pattern of the serial graph. At last the tree pattern of the graph should be coded into binary code for storage. The tree is only logical expression for computer processing. During the procedure of automated devise, the conversion from graph to tree is very important.

Quick determining the level of the item is very important to determine the intelligence level of the examinees. The invention predicates the level of the difficulty using the similarity of the optional answers (includes the correct answer and the distracters), difficulty of the rules, and the complexity of the sub-graph. With the prediction of the level of the difficulty, it also should be discrete, normalized and sampled making the results suitable to ‘item response theory’. The constant coefficients of the equations can be calculated out by inverting the operations from the known items.

The invention is particularly suitable to use in performing the intelligence test. As part of the intelligence test system, the items are suitable to the item response theory, and can break through the barrier of culture, language, and education background. The invention can be utilized as the tool of evaluating the abilities and intelligence of the examinee. It can also be used to enlist the international employee for corporations. For the medical aspect, it can be used as the tools to judge the recovery process of stroke and brain injury patients etc.

### BRIEF DESCRIPTION OF THE DRAWINGS

In the detailed description of the embodiments of the invention presented below reference is made to the accompanying drawings in which:

FIG. 1 is the figure of constructing components of automated item generator of graphic intelligence test.

FIG. 2 is part of graph shape database.

FIG. 3 is an example matrix graph with 9 sub-graphs.

FIG. 4 is part of the sample demonstration of 12 branch tree from FIG. 3.

FIG. 5 is the division of a sub-graph.

FIG. 6 is the operation of 9 cells of a sub-graph to implement the rule of flipping top to bottom.

FIG. 7 is the operation sequence from the original sub-graph to the second sub-graph.

FIG. 8 is the generation of three wrong answers.

FIG. 9 is the class diagram of the matrix graph item.

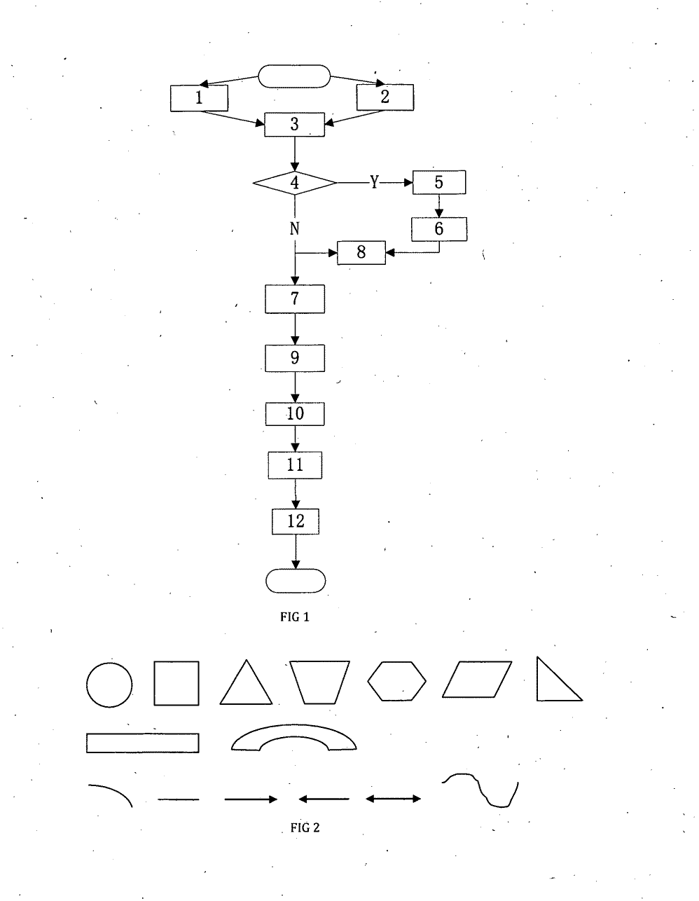

Of FIG. 1: 1 represents the shape database; 2 represents the texture database; 3 represents the one shingle graph object; 4 represents the judgments for whether the number of object>1 ?; 5 represents the local rule database; 6 represents the sub-graph object; 7 represents the sub-graph block; 8 represents the optional (distract) answers; 9 represents the global rules; 10 represents the tree pattern expression of the graph; 11 represents one sample item; 12 represents prediction of the difficulty; 13 represents the validation of the difficulty; 14 represents the database & online test platform.

Of FIG. 4: 1 represents node of the tree; 2 represents rules 1; 3 represents rules 9; 4 represents sub-tree 1; 5 represents sub-tree 2; 6 represents sub-tree 8; 7 represents sub-tree 9; 8 represents texture 2; 10 represents texture n; 11 represents shape 1; 12 represents shape 2.

### DESCRIPTION OF THE PREFERRED EMBODIMENT

The invention composes of Automated Item Generator and Difficulty prediction model.

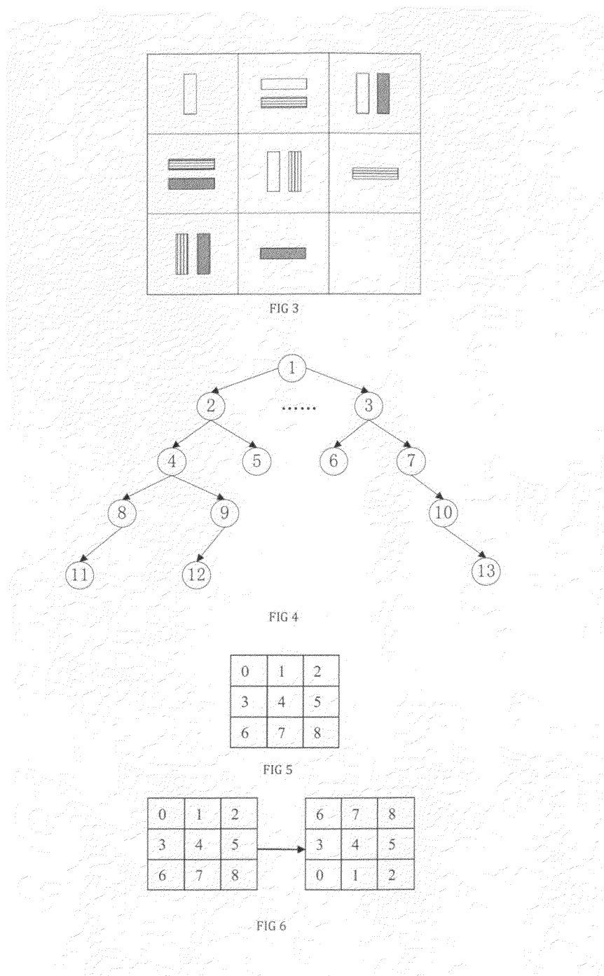

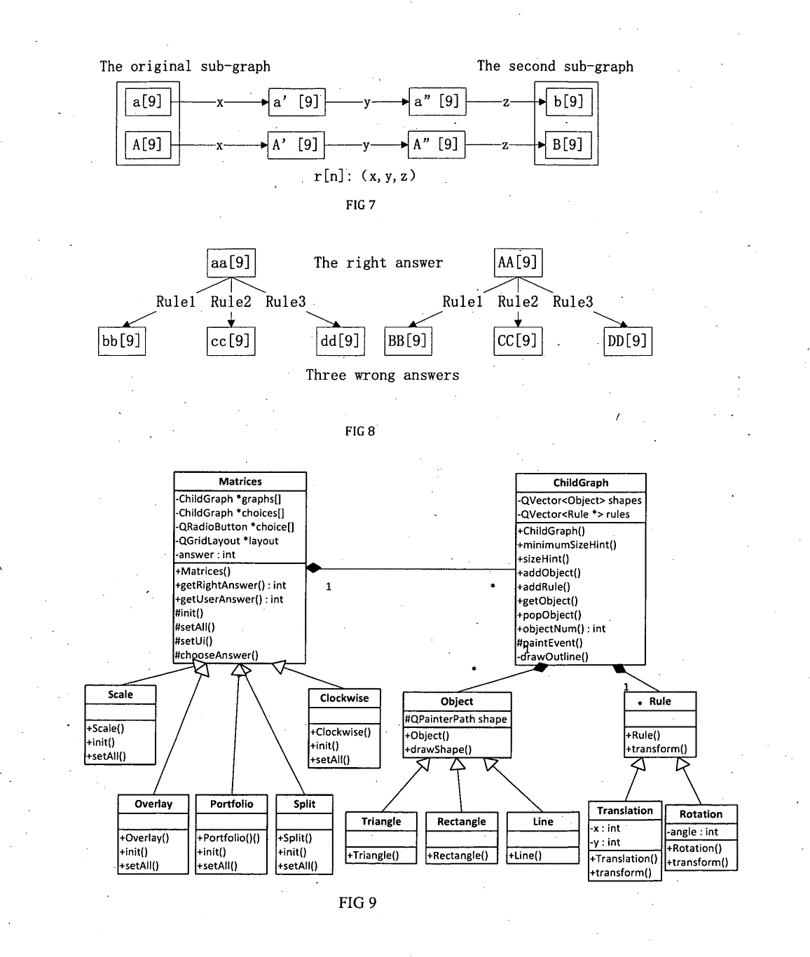

FIG. 1 is the principle graph of the model and algorithm for automated item generator of the graphic intelligence test. FIG. 2 is a sample of shape database. FIG. 3 is the sample item (11) created by FIG. 1. FIG. 4 is the tree pattern expression (10) of FIG. 1.

For automated item generator, 12_branch tree model has been devised representing the matrix graph item, and 8_branch tree model represents serial graph item. By retrieving the 12_branch tree and 8_branch tree, big amount of items can be generated. Difficulties of the item validating model also have been devised. The invention compromises two parts: automated item generator and item difficulty predication model. ‘The general shape database’ (FIG. 2), ‘texture database’ (FIG. 3), ‘rule database’ (FIG. 4) are designed firstly for automated item generator. When constructing the item, randomly select the elements from the database, they construct the nine sub-graphs using the elements (FIG. 3). From the 9 sub-graphs, a matrix graph can be built up. With the matrix graph, a 9 sub-branch tree can be generated. From the 9 sub-branch tree, 3 sub-branch parts (distracters) can be built up by modifying small part of the sub-branch tree, then totally 12 sub-branch tree (FIG. 4) is constructed. When construct 3 distracters, what we need to do is just modify one or two node of the sub-tree. Besides this, we also need to be careful about the shape and texture should be the elements of the sub-tree. Distracters cannot be generated by modifying any node of the 9 sub-tree. The whole 12 tree is a pattern of one item. For the serial graph problem, the method is similar. Initially 5 branch tree can be set up firstly instead of the 9 branch tree, and then the 8 branch tree is set up as the pattern of the serial graph. At last the tree pattern of the graph should be coded into binary code for storage. The tree is only logical expression for computer processing. During the procedure of automated devise, the conversion from graph (FIG. 3) to tree (FIG. 4) is very important.

The mathematic model of validate the difficulty level is presented as:

1) assume λ is the difficulty attribute, α is the shape attribute, β is the complexity coefficient.

λ=κ₁α+k₂β; k₂>=1

2) φ is the difficulty attribute of each rule. From one shingle attribute, the composite difficulty attributes can be calculated out.

$$ϕ = {\prod }_{i} {ϕ}_{i} ;$$

i is the number of the rule

3) τᵢ is the similarity attributes of the optional answers

$$τ = {\sum }_{i} {τ}_{i} ;$$

i is the number of the optional answer

4) is the difficulty prediction of one item

v=n₁λ+n₂φ+n₃τ; n₁n₂, n₃

are the constant coefficients

5) The predicated difficulty of the item should be sampled, discrete and normalized to make it adapted to item response theory.

### EXAMPLE 1

According to the basic embodiment, the invention utilizes two kinds of methods. In the procedure-oriented method, general shapes, textures and rules in the database are numbered firstly for automated item generator. A series graph item consists of 8 sub-graphs and two rule sets. One records the generating rule of the four sub-graphs for differencing the right answer, and the other records the generating rule of three wrong optional answers. Every sub-graph can be recorded by the array a[9]. The index represents the cell number of the sub-graph. The value represents the number of the shape in the cell. The array A[9] of the index represents the cell number of the sub-graph. The value represents the number of the texture filled in the shape of the cell. The whole item can be recorded by two 2-dimension array a[8][9] and A[8][9] representing the 8 sub-graphs. The two rule arrays r[n] of the index mean the executing sequences of the rules. The value means the rules' number selected to generate the sub-graphs and R[3], of which the value means the rule's number selected to generate the wrong answers. If convert the four arrays into a string code in order, a series graph item can be stored in the item bank as a code and can be generated from the code accurately. To avoid getting same items, just need to compare the code of two items.

### EXAMPLE 2

For the object-oriented method, take all parts of the matrix graph item for objects. Thus use the class Matrices to represent the whole matrix graph item and the class ChildGraph to represent the sub-graph. The subclasses of the class Matrices corresponds to different kinds of matrix graph items. The class Matrices has members which are objects of the class ChildGraph. The class ChildGraph has two member arrays. One is the class Object representing the general shapes in the sub-graph, and the other is the class Rule representing the basic translation of the shapes. To generate a matrix graph item, firstly initialize the sub-graphs in the first column, which means to call the member function of the class ChildGraph to add shapes to the 0^{th}, 3^{rd} and 6^{th} term in the member array of the class ChildGraph. The selection of shapes is random. Secondly, call the member function to generate the whole item. For items of different rules, the member function is different in different subclasses of the class Matrices. Call the member function of the class ChildGraph to add basic rules into every sub-graph and combine these basic rules to make the item which follows the rule type of this item. Then locate the right answer randomly in the options and combine basic rules and general shapes randomly to generate three wrong answers. Due to the object-oriented method, its best advantage is the expansion ability.

I claim:

1. A model and algorithm for automated item generator of the graphic intelligence test adapted to test the intelligence and ability of the examinees;
An automated item generator of the graphic intelligence test utilize ‘tree’ as the pattern to express the graph item for further process and storage;
The difficulty of the item generated by the model is presented with the similarity of the optional answers, difficulty of rules, and the complexity of the sub-graph;

2. A model and algorithm for automated item generator of the graphic intelligence test (FIG. 1) as defined in claim 1, is composed by FIG. 1:
1. shape database, 2. texture database, 3. shingle graph object, 4. judgement of whether number of object>1?, 5. local rule database, 6. sub-graph object, 7. create the sub-graph block, 8. create optional answers, 9. global rule, 10. tree expression, 11. item, 12. difficulty prediction, 13. difficulty validation, 14. database & online test platform,

3. A tree as defined in claim 1 wherein:
said first tree pattern is 12 branch tree representing the matrix graph; Within the 12 branch tree, 9 sub-tree expresses the matrix together with one 3 branch sub-tree representing three false distracting answers. said second tree pattern is 8 branch tree representing the series graph; within the 8 branch tree, 5 sub-tree expresses the series together with one 3 branch sub-tree representing three false distracting answers.

4. The tree (FIG. 4) of claim 3 includes: 1. root node, 2 rule 1, 3 rule 9, 4 sub-tree 1, 5 sub-tree 2, 6 sub-tree 8, 7 sub-tree 9, 8 texture 1 , 9 texture 2, 10 texture n, shape 1, 12 shape 2.

5. The difficulty of the item defined in claim 1 wherein said the difficulty generated by similarity of the optional answers, the difficulty of the rules, and the complexity of the sub-graph.

6. The difficulty of in claim 5 wherein said the difficulty need to be discretized, sampled and normalized. In this way, the final difficulty results are suitable to item response theory.

7. The difficulty of the rules in claim 5 wherein said the constant coefficients can be deducted from the known old items using the invert operation, which can used further to generate new items.
